(19) United States
(12) Patent Application Publication
(10) Pub. No.: US 2025/0245626 A1
(43) Pub. Date: Jul. 31, 2025

(54) SYSTEM, TERMINAL DEVICE, AND METHOD

(71) Applicant: Preferred Networks, Inc., Tokyo (JP)

(72) Inventors: Yoichi YAMAKAWA, Tokyo (JP); Shunta SAITO, Tokyo (JP)

(21) Appl. No.: 19/092,283

(22) Filed: Mar. 27, 2025

Related U.S. Application Data
(63) Continuation of application No. PCT/JP2023/034497, filed on Sep. 22, 2023.

(30) Foreign Application Priority Data
Sep. 29, 2022 (JP) 2022-157022

(51) Int. Cl. G06Q 10/0875

(52) U.S. Cl. CPC G06Q 10/0875

(57) ABSTRACT

A system for managing locations of products includes one or more memories, and one or more processors. The one or more processors are configured to: read an information medium attached to a storage unit loaded with at least one first product, the storage unit being located in a stockroom in a retail store having a sales floor; associate the first product loaded on the storage unit located in the stockroom and a location in the stockroom with each other, using information acquired from reading the information medium attached to the storage unit; and notify a terminal device of the location in the stockroom associated with the first product when the stockroom is searched for the first product with the terminal device.

### CROSS-REFERENCE TO RELATED APPLICATIONS

This application is a continuation application of International Application No. PCT/JP2023/034497 filed on Sep. 22, 2023, and designated the U.S., which is based upon and claims priority to Japanese Patent Application No. 2022-157022 filed on Sep. 29, 2022, the entire contents of which are incorporated herein by reference.

### BACKGROUND

### 1. Technical Field

The present disclosure relates to a product location management system and a terminal device.

### 2. Description of Related Art

In a conventional operation of searching for a product in a stockroom for the purpose of replenishing a product that is out of stock or is running out of stock in a sales floor of a store or for the purpose of displaying a product unpacked from a box such as a corrugated fiberboard box, an employee searches for the product by looking at products loaded on wheeled stockroom carts in a place where the employer thinks the product that is searched for is likely to be stored, relying on the employee's memory and knowledge regarding the category of the product (see, for example, Japanese Unexamined Patent Publication No. 2003-30750, hereinafter, “Patent Document 1”).

### SUMMARY

According to an embodiment of the present disclosure, a system for managing locations of products includes one or more memories, and one or more processors. The one or more processors are configured to: read an information medium attached to a storage unit loaded with at least one first product, the storage unit being located in a stockroom in a retail store having a sales floor; associate the first product loaded on the storage unit located in the stockroom and a location in the stockroom with each other, using information acquired from reading the information medium attached to the storage unit; and notify a terminal device of the location in the stockroom associated with the first product when the stockroom is searched for the first product with the terminal device.

### BRIEF DESCRIPTION OF THE DRAWINGS

FIG. 1 is a diagram for explaining delivery of products from a delivery center to a retail store according to an embodiment of the present disclosure;

FIG. 2 is a diagram for explaining each wheeled stockroom cart placed in each area according to an embodiment of the present disclosure;

FIG. 3 is a view illustrating a state of a wheeled stockroom cart according to an embodiment of the present disclosure;

FIG. 4 is an example of an area board according to an embodiment of the present disclosure;

FIG. 5 is an example of an overall configuration according to an embodiment of the present disclosure;

FIG. 6 is a functional block diagram of the product location management server according to an embodiment of the present disclosure (registration of product location);

FIG. 7 is an example (Example 1) of a database according to an embodiment of the present disclosure;

FIG. 8 is an example (Example 2) of the database according to an embodiment of the present disclosure;

FIG. 9 is a functional block diagram of the product location management server according to an embodiment of the present disclosure (notification of a product location);

FIG. 10 is a transition diagram of a target product list according to an embodiment of the present disclosure;

FIG. 11 is a sequence diagram of a process of providing a notification of a product location according to an embodiment of the present disclosure (Embodiment 1);

FIG. 12 is a sequence diagram of a process of providing a notification of a product location according to an embodiment of the present disclosure (Embodiment 2);

FIG. 13 is an example of a home screen displayed on a terminal device according to an embodiment of the present disclosure;

FIG. 14 is a transition diagram of a screen displayed on a terminal device according to an embodiment of the present disclosure (Embodiment 1);

FIG. 15 is a transition diagram of a screen displayed on a terminal device according to an embodiment of the present disclosure (Embodiment 2); and

FIG. 16 is a hardware configuration diagram of a product location management server, a delivery center management server, and a terminal device according to an embodiment of the present disclosure.

### DETAILED DESCRIPTION

In a conventional operation, information appropriate for searching for a product is not provided to a person who searches for the product, and thus the work of searching for a product is inefficient, and it takes a long time to find a desired product. An object of the present disclosure is to facilitate the operation of searching for a product in a stockroom of a store.

Hereinafter, embodiments of the present disclosure will be described with reference to the drawings.

### Explanation of Terms

In the present specification, a “retail store” is a store that sells products to consumers. For example, the retail store may be, but is not limited to, a supermarket, a drug store, a convenience store, a department store, a hardware store, etc.
In the present specification, a “delivery center” is a business operator that receives products from a product manufacturer or the like and ships the products to a retail store (also referred to as a “distribution center”).
In the present specification, a “product(s)” may be any product(s).
In the present specification, a “sales floor” is a place where products are sold to consumers in a store.
In the present specification, the “stockroom” is a place in the store where inventory of products sold in the sales floor (inventory products to be supplied to the sales floor) are stored (also referred to as a storage or a warehouse). Even in the case where a stockroom is provided in a store including a sales floor, the store is considered to include a sales floor and a stockroom.
In the present specification, an “area” is a region in which the wheeled stockroom cart is placed in a stockroom.
In the present specification, a “wheeled stockroom cart” is a tool for transportation that can be moved while being loaded with a product (also referred to as a “cart” or a “wagon”). The wheeled stockroom cart is moved in the stockroom, with products being loaded thereon. The products are stored at a destination of the wheeled stockroom cart, being loaded on the wheeled stockroom cart. For example, products are delivered from a delivery center to a stockroom of a retail store, being loaded on a wheeled stockroom cart.
In the present specification, a “container” is a container (for example, a box such as a corrugated fiberboard box) in which a product is packed.

### <Outline>

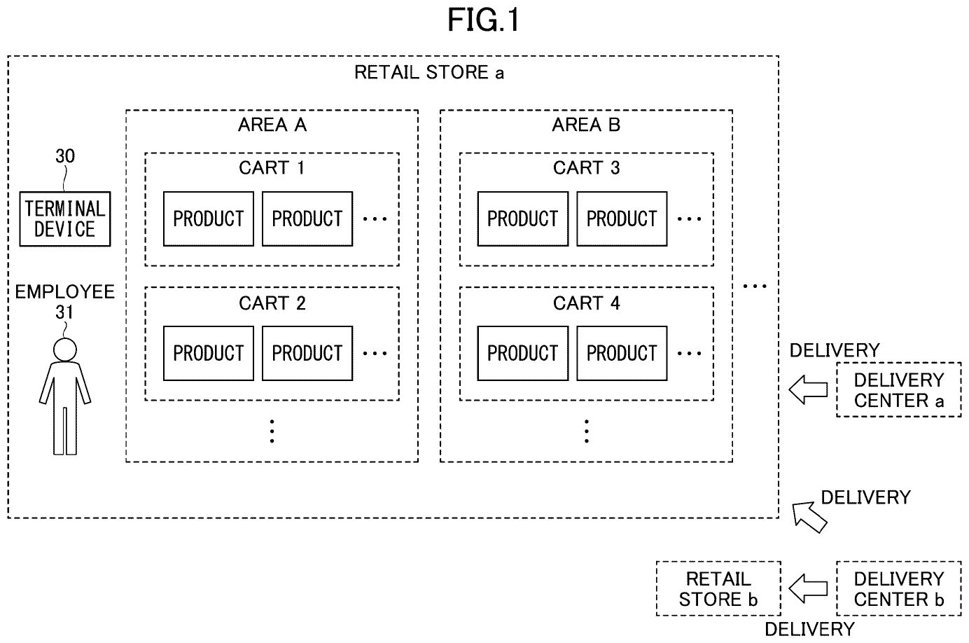

FIG. 1 is a diagram for explaining delivery of products from a delivery center to a retail store according to an embodiment of the present disclosure. The number of retail stores, the number of delivery centers, the number of areas, the number of carts, the number of terminal devices, and the number of employees in FIG. 1 are merely examples, and the present invention is not limited to these.

To each retail store (retail store a and retail store b in the example of FIG. 1), products are delivered from one or more delivery centers. For example, products are delivered to the retail store a from a plurality of delivery centers (delivery center a and delivery center b in the example of FIG. 1), and products are delivered to the retail store b from one delivery center (delivery center b in the example of FIG. 1).

The stockroom of the retail store has one or more areas (in the example of FIG. 1, retail store a has area A, area B, etc.). For example, the area is a predetermined section in the stockroom (for example, a section divided by a line drawn on the floor of the stockroom). Instead of determining the sections in advance, a place where a plurality of wheeled stockroom carts, for example ten wheeled stockroom carts, to be placed at the place are placed may be defined as an area.

One or more wheeled stockroom carts are placed in each area. In the example of FIG. 1, cart 1, cart 2, etc. are placed in area A, and cart 3, cart 4, etc. are placed in area B.

Each wheeled stockroom cart (storage unit) is loaded with one or more products. For example, one or more containers (for example, a box such as a corrugated fiberboard box) in each of which one or more pieces of a product are packed are loaded on each cart.

A certain product (for example, product a) may be present in a plurality of areas (for example, product a may be present in both area A and area B). In addition, a certain product (for example, product a) may be present in a plurality of carts (for example, product a is present in cart 1, cart 2, cart 3, and cart 4).

An employee 31 in the stockroom of the retail store operates a terminal device 30.

A store according to an embodiment of the present disclosure includes a sales floor and a stockroom. As described above, the stockroom has one or more areas. The products loaded on a truck or the like and delivered from the delivery center are delivered from the truck or the like to the stockroom through the products carry-in entrance, and then the employee 31 supplies the products from the stockroom to the sales floor through the entrance/exit connecting the stockroom and the sales floor as necessary.

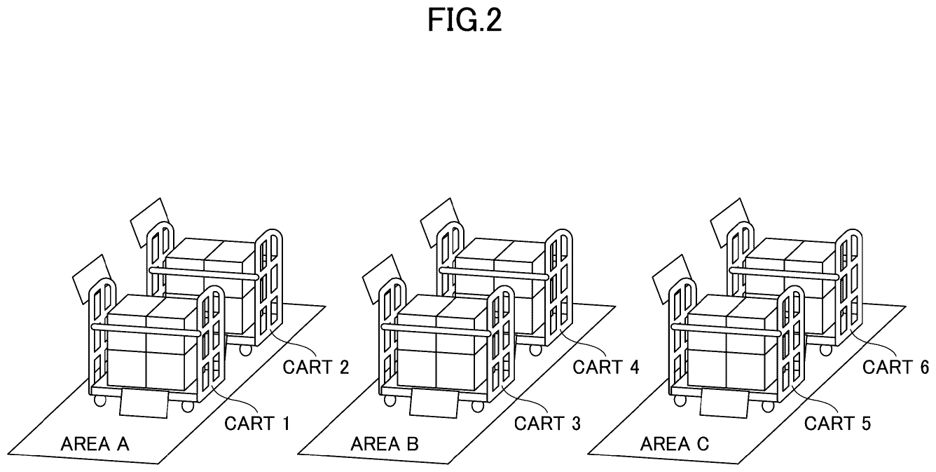

FIG. 2 is a diagram for explaining each wheeled stockroom cart placed in each area according to an embodiment of the present disclosure. One or more wheeled stockroom carts are placed in each area. FIG. 2 illustrates a situation in which two wheeled stockroom carts are placed in each of three areas. The shape and type of the cart are merely examples, and the cart may have any shape and type.

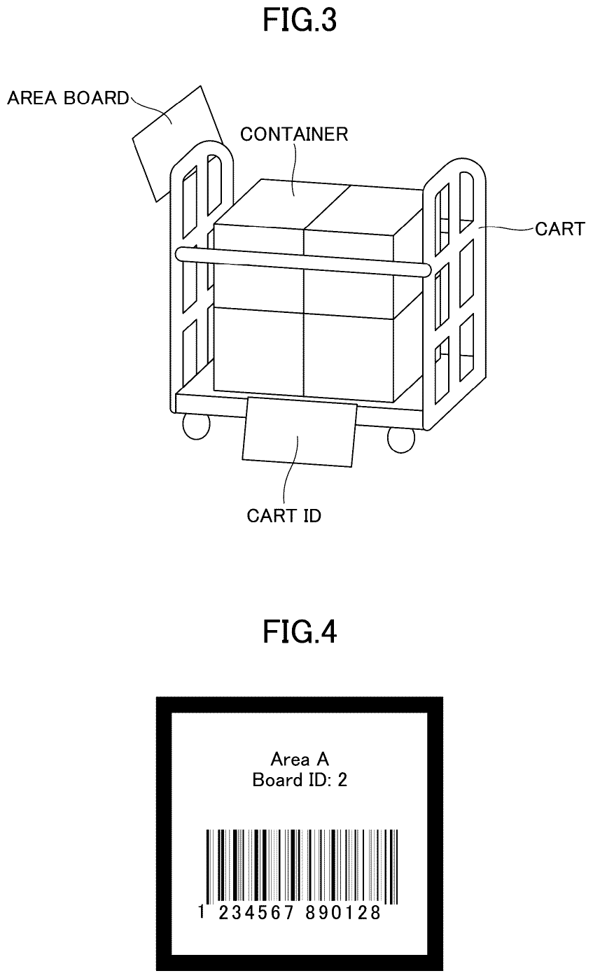

FIG. 3 is a diagram illustrating a state of the wheeled stockroom cart according to the embodiment of the present disclosure. As illustrated in FIG. 3, for example, one or more containers (for example, boxes such as corrugated fiberboard boxes) in each of which one or different kinds of products are packed are loaded on the cart.

An information medium (a paper medium, an electronic medium such as an IC tag, or the like) including a cart ID is attached to each cart (storage unit). For example, the information medium including the cart ID is a medium (for example, a plate, a sticker, a badge, or the like) that displays a character string of the cart ID and a code such as a barcode obtained by encoding the cart ID. The position of the information medium attached to the wheeled stockroom cart is not limited to a specific position. In the description hereinafter, the cart is delivered, with the information medium including the cart ID being attached to the cart. There is a case where a product loaded on a plurality of carts may be transferred to one cart at the delivery center, and in this case, the one cart may be delivered, with the information medium including the cart ID of each of the plurality of carts being attached. In other words, an information medium including one or more cart IDs is attached to the delivered cart.

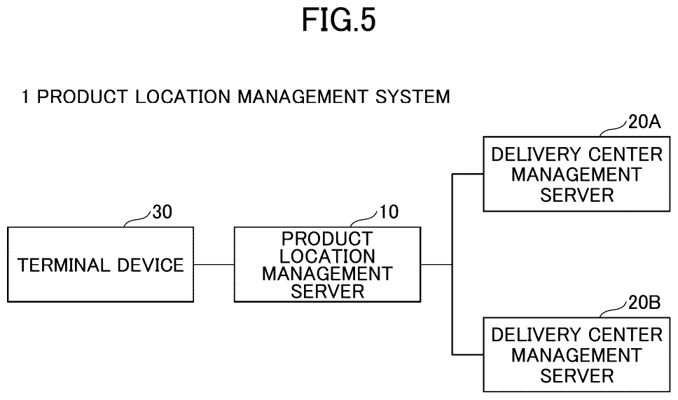

One area board is attached to each wheeled stockroom cart (e.g., on the top of a wheeled stockroom cart). The area board will be described in detail below with reference to FIG. 4.

### (Area Board)

FIG. 4 is an example of an area board according to an embodiment of the present disclosure. As described above, one area board is attached to one cart. When the cart loaded with products is delivered to the stockroom, the employee of the store attaches an area board to the cart.

The area board is an information medium (for example, a plate, a sticker, a badge, or the like) that displays an area ID (“A” in the example of FIG. 4) that is information specifying an area and a board ID (“2” in the example of FIG. 4) that is information specifying the area board in such a manner that a person can read the information, and displays a code such as a barcode obtained by encoding information (for example, information indicating a board ID that is associated with an area ID in advance and does not overlap between areas or information indicating both an area ID and a board ID) that can uniquely specify the area board in the stockroom. The area ID and the board ID of the area board attached to each cart are information used by a person who searches for a target product to find the cart on which the target product is loaded from the stockroom, and are information associated with the cart. Hereinafter, this information is referred to as “area board identification information”.

It is preferable that the board ID can be uniquely identified in the stockroom (in other words, the board ID does not overlap between areas) from the viewpoint of the search for the area board by the employee 31. However, the board ID may overlap between areas as long as the area board can be uniquely identified in the stockroom from both the area ID and the board ID.

The area board may be colored in a color corresponding to the area (in the example of FIG. 4, the frame of the area board may be colored) so that the employee 31 can easily identify the area.

### <Overall Configuration Example>

FIG. 5 is an example of an overall configuration according to an embodiment of the present disclosure. The product location management system 1 includes a product location management server 10 and a terminal device 30. The product location management system 1 may further include one or more delivery center servers (in the example of FIG. 5, a delivery center management server 20A and a delivery center management server 20B. Hereinafter, one or more delivery center management servers are collectively referred to as a “delivery center management server 20”). Each of these are described below.

### <<Product Location Management Server>>

The product location management server 10 is an information processing apparatus (data processing apparatus) that manages products in a store. Specifically, the product location management server 10 manages locations of products in the stockroom of the store and notifies the terminal device 30 of the locations. The product location management server 10 is constituted by one or a plurality of computers. The product location management server 10 can transmit and receive data to and from the terminal device 30 and the delivery center management server 20. The product location management server 10 may manage a plurality of retail stores, or the product location management server 10 may manage one retail store (in other words, the product location management server 10 is installed at each retail store).

### <<Delivery Center Management Server>>

The delivery center management server 20 transmits an acceptance list of products to be delivered from the delivery center to the retail store (specifically, information including products to be delivered from the delivery center to the retail store, the number of pieces of each product, and cart IDs of the carts on which the products are loaded) to the product location management server 10.

### <<Terminal Device>>

The terminal device 30 is an information processing apparatus (data processing apparatus) that is carried and operated by the employee 31 (user) of the store. For example, the terminal device 30 may be any terminal that includes a display and is suitable for being carried, such as a handheld terminal, a tablet, a smartphone, or a smart watch.

### <Functional Block (Registration)>

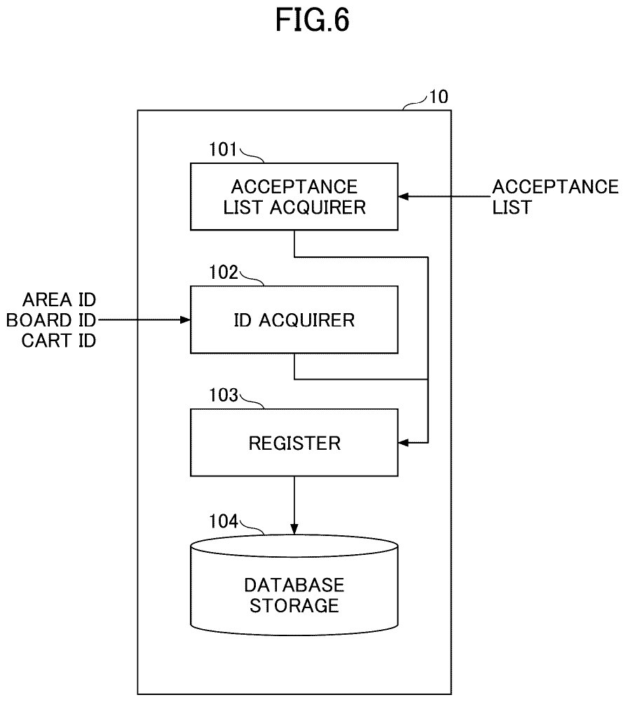

FIG. 6 is a functional block diagram of the product location management server 10 according to an embodiment of the present disclosure in the registration of a product location. The product location management server 10 includes an acceptance list acquirer 101, an ID acquirer 102, a register 103, and a database storage 104. The product location management server 10 functions as the acceptance list acquirer 101, the ID acquirer 102, and the register 103 by executing a program.

The acceptance list acquirer 101 acquires an acceptance list (specifically, information including a product to be delivered from the delivery center to the retail store, the number of pieces of the product, and a cart ID of the cart on which the product is loaded) from the delivery center management server 20. The acceptance list acquirer 101 may acquire an acceptance list before products are actually delivered, or may acquire an acceptance list after products are actually delivered.

The ID acquirer 102 acquires a cart ID of a cart delivered to the stockroom of the store and area board identification information of an area board attached to the cart from the terminal device 30 of the employee in the stockroom (or any terminal device).

The register 103 associates the acceptance list acquired by the acceptance list acquirer 101, the cart ID acquired by the ID acquirer 102, and the area board identification information with each other by the cart ID and causes the database storage 104 to store these information items. Thus, the register 103 registers a product (for example, a product ID) in the database by associating the product with a cart on which the product is loaded (for example, a board ID), the number of pieces of the product loaded on the cart (for example, the number of boxes), and a location at which the cart is placed (for example, an area ID). The register 103 can also delete a record registered in the database.

The database storage 104 stores a database including the acceptance list acquired by the acceptance list acquirer 101, the cart ID acquired by the ID acquirer 102, and the area board identification information. In other words, the database storage 104 stores a database in which a product (for example, a product ID) is associated with each of a cart on which the product is loaded (for example, a board ID), the number of pieces of the product loaded on the cart (for example, the number of boxes), and a location at which the cart is placed (for example, an area ID). It is possible to specify, for a certain product, the cart on which the product is loaded, the number of pieces of the product loaded on the cart, and the position where the cart is placed, by referring to this database.

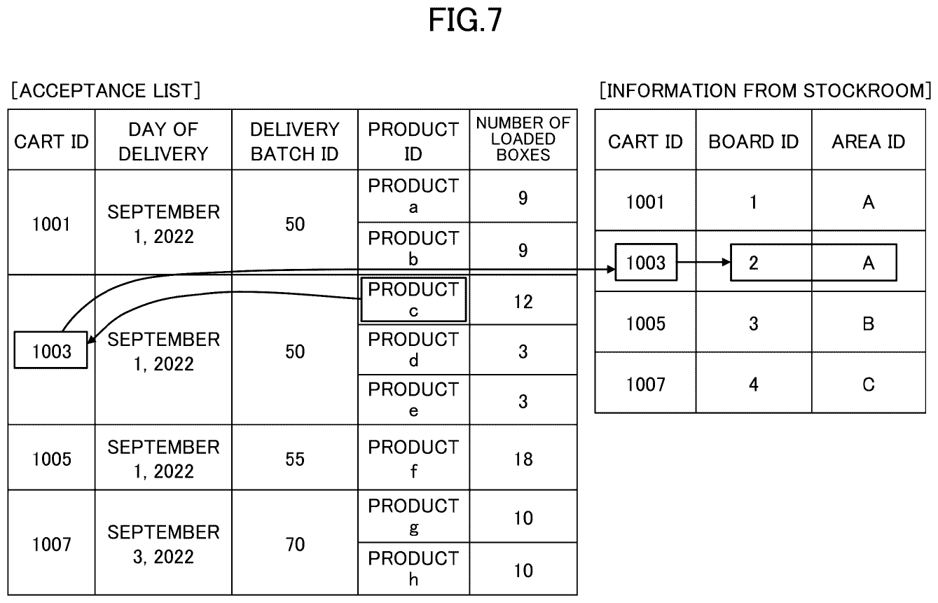

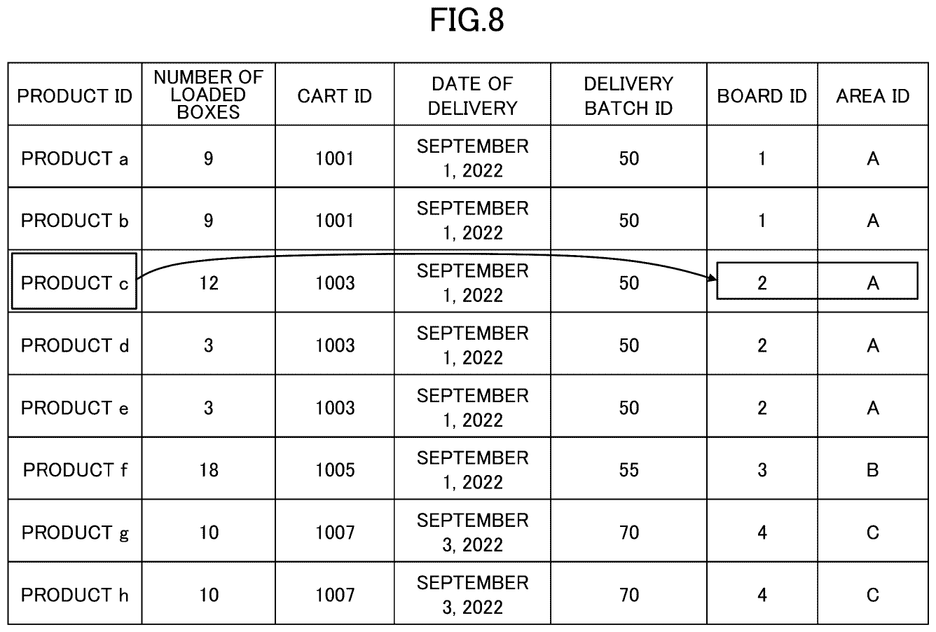

The database stored in the database storage 104 will be described below with reference to FIGS. 7 and 8. As described below, information of a product, a cart on which the product is loaded, and an area in which the cart is placed are directly or indirectly associated with each other and stored in the database.

FIG. 7 is an example (Example 1) of the database according to an embodiment of the present disclosure. In the database, a plurality of tables (a table of [Acceptance List] and a table of [Information from Stockroom]) are associated with each other by the cart ID.

The [Acceptance List] includes, for each cart, a “cart ID”, a “date of delivery”, a “delivery batch ID”, a “product ID”, and a “number of loaded boxes”. Each of these are described below.

The “cart ID” is an identifier of a cart, which is assigned to each cart to be delivered from the delivery center to the retail store.

The “date of delivery” is a date on which the delivery center delivers the product to the retail store.

The “delivery batch ID” is an identifier of a delivery.

The “product ID” is an identifier of one or more types of products loaded on the cart. For example, the product ID is a product name, a GTIN (JAN code) of the products, or the like. Different types of products may be loaded on one cart. In the present disclosure, the term “product” may be “information (for example, a product ID) for specifying products” depending on the context.

The “number of loaded boxes” is the number of containers (for example, boxes such as corrugated fiberboard boxes) of each type of merchandise loaded on the cart.

The [Information from Stockroom] (i.e., the information acquired from the terminal device 30 (or another terminal device) of the employee in the stockroom) includes a “cart ID”, a “board ID”, and an “area ID” for each cart. Each of these are described below.

The “cart ID” is an identifier of a cart, which is assigned to each cart placed in the stockroom (that is, a cart delivered from the delivery center to the retail store).

The “board ID” is an identifier of the area board attached to the cart. In the present disclosure, the term “cart” may be read as information specifying an area board attached to the cart (for example, a board ID), depending on the context.

The “area ID” is an identifier of an area where the cart is placed. The area where the cart is placed is a destination of the cart in the case where the cart is moved with a product loaded thereon and stores the product loaded thereon at the destination. In the present disclosure, the term “area” may be read as information specifying an area (for example, an area ID), depending on the context.

In the case where the “area board identification information” indicated by the code displayed on the area board is information indicating a board ID associated with the area ID in advance and not overlapping between areas, the board ID and the area ID are associated with each other in advance and stored in the database so that the area ID can be specified from the board ID. On the other hand, in the case where the “area board identification information” indicated by the code displayed on the area board is information indicating both the area ID and the board ID, the area ID and the board ID acquired from the stockroom are stored in the database.

In the case where a cart on which a certain product is loaded and an area where the cart is placed are specified using the database illustrated in FIG. 7, the [Acceptance List] table is searched for a record of one or more cart IDs including the product ID of the product, and the [Information from Stockroom] table is searched for a record including the one or more cart IDs to specify the board ID and the area ID in the record. In this way, the cart on which the target product is loaded and the area where the cart is placed can be specified. For example, it can be specified that the cart loaded with product c is the one with the area board indicating the area ID “A” and the board ID “2” and placed in the area “A”.

FIG. 8 is an example (Example 2) of the database according to an embodiment of the present disclosure. As illustrated in FIG. 8, the [Acceptance List] and the [Information from Stockroom] in FIG. 7 may be merged into one table and managed.

In the case where a cart on which a certain product is loaded and an area in which the cart is placed are specified using the database illustrated in FIG. 8, the merged table is searched for one or more records including the product ID of the product, and the board ID and the area ID of the record are specified. In this way, the cart on which the target product is loaded and the area where the cart is placed can be specified. For example, it can be specified that the cart loaded with product c is the one with the area board indicating the area ID “A” and the board ID “2” and placed in the area “A”.

### <Method (Registration)>

A process of registering and a process of deleting a product location according to an embodiment of the present disclosure will be described.

### Registration Example 1

When a cart is delivered to the stockroom, the employee 31 in the stockroom has the terminal device 30 read the barcode or the like of one or more cart IDs attached to the cart by the terminal device 30, and subsequently read the barcode or the like of one area board corresponding to the area where the cart is placed (namely, the area board on which the area ID of the area where the cart is placed is displayed). Thus, the terminal device 30 acquires one or more cart IDs and area board identification information to be associated with each other, and notifies the product location management server 10 of the one or more cart IDs and the area board identification information. The product location management server 10 has the cart ID and the area board identification information stored in, for example, one record of a table for each of one or more cart IDs provided from the terminal device 30, and generates data in which the cart ID, the board ID, and the area ID are associated with each other. Since the product location management server 10 stores the product ID and the cart ID associated with each other in the acceptance list table received from the delivery center management server 20, the product ID, the board ID, and the area ID are associated with each other by this data generation. The employee 31 attaches the area board to the cart and moves the cart to the area corresponding to the area board. By such an operation, it is possible to specify a cart (board ID) on which a certain product is loaded and an area (area ID) in which the cart is placed.

### Registration Example 2

When loading products on a cart, the employee 31 in the stockroom has the terminal device 30 read a barcode or the like of a GTIN (JAN code) attached to a container of each product (for example, a box such as a corrugated fiberboard box), and subsequently read a barcode or the like of an area board corresponding to an area where the cart is placed (namely, an area board on which an area ID of the area where the cart is placed is displayed). Thus, the terminal device 30 acquires the product ID and the area board identification information to be associated with each other, and notifies the product location management server 10 of the product ID and the area board identification information. The product location management server 10 has the product ID and the area board identification information provided from the terminal device 30 stored in one record of the table, and generates data in which the product ID, the board ID, and the area ID are associated with each other. The employee 31 attaches the area board to the cart and moves the cart to the area corresponding to the area board. By such an operation, it is possible to specify a cart (board ID) on which certain products are loaded and an area (area ID) in which the cart is placed.

### Registration Example 3

Transferring all products loaded on cart p already associated with an area board to cart q associated with another area board can be performed as follows. The employee 31 has the terminal device 30 read the barcode or the like of the area board of cart p which is a wheeled stockroom cart (storage unit) of the transfer source, and subsequently read the barcode or the like of the area board of cart q which is a wheeled stockroom cart of the transfer destination, and transfers all the products loaded on cart p to cart q. The terminal device 30 acquires area board identification information by reading the barcodes or the like on the area boards of cart p as the transfer source and cart q as the transfer destination, and notifies the product location management server 10 of the identification information of each area board. For each product managed in the database and associated with the area board identification information of cart p as the transfer source provided from the terminal device 30 (namely, each product managed in the database as being loaded on cart p), the product position management server 10 rewrites the board ID and the area ID currently associated with each other in the database with the area board identification information (board ID and area ID) of cart q as the transfer destination provided from the terminal device 30. Then, the employee 31 moves cart q to the corresponding area, removes the area board from cart p, and returns cart p to the delivery center. This operation enables the database to be updated in response to the transfer of products between the carts to which the area boards are attached.

### Deletion Example 1

When the terminal device 30 notifies the product location management server 10 that a product registered in the database is not found in the database from the carts placed in the area associated with the product, the product location management server 10 deletes from the database the record in which the product (product ID), the cart on which the product is loaded (area board identification information), and the area in which the cart is placed (area ID) are associated with each other. For example, when a “Not found” button displayed on the terminal device 30 is designated for a product that is supposed to be loaded on a certain cart placed in a certain area, the product location management server 10 deletes a record in which the product, the cart, and the area are associated with each other.

### Deletion Example 2

When the terminal device 30 notifies the product location management server 10 that the information of the cart (area board identification information) registered in the database is reset (deleted) in the database, the product location management server 10 deletes all records in which the cart (area board identification information) is associated with the area where the cart is placed (area ID) and all products loaded on the cart (product IDs) from the database. For example, when the barcode or the like of the area board attached to the cart is scanned by the terminal device 30 after the “Reset” button displayed on the terminal device 30 is designated, the product location management server 10 deletes all records including the area ID and the board ID of the scanned area board.

### <Functional Block (Notification)>

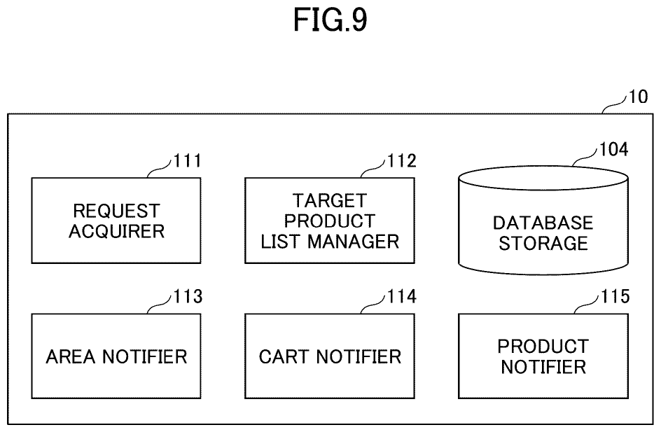

FIG. 9 is a functional block diagram of the product location management server 10 according to an embodiment of the present disclosure (notification of product location). The product location management server 10 includes a request acquirer 111, a target product list manager 112, an area notifier 113, a cart notifier 114, a product notifier 115, and a database storage 104. The product location management server 10 functions as the request acquirer 111, the target product list manager 112, the area notifier 113, the cart notifier 114, and the product notifier 115 by executing a program.

The request acquirer 111 acquires a request for providing a notification of a production location from the terminal device 30.

The target product list manager 112 generates and manages a list (hereinafter, also referred to as a “target product list”) of products (hereinafter, also referred to as “target products”) to be supplied from the stockroom to the sales floor. The target product list may include information (product ID) for specifying each product to be supplied from the stockroom to the sales floor, information (board ID) for specifying a cart on which the product is loaded, information (area ID) for specifying an area in which the cart is placed, and the number of pieces of the product to be taken out from the cart (for example, the number of containers).

### (Generation of Target Product List)

The target product list manager 112 specifies a product (target product) to be supplied from the stockroom to the sales floor. The target product list manager 112 refers to the database stored in the database storage 104 and specifies the cart on which each product (target product) to be supplied from the stockroom to the sales floor is loaded and the area in which the cart is placed.

Specifically, the target product list manager 112 specifies a product (product ID) that is a target to be searched for by the employee 31 from the stockroom. The method of specifying a target product is not limited; for example, the target product list manager 112 may specify, as a target product, a product whose filling rate of displayed products calculated from a moving image of the sales floor captured by a camera installed in the sales floor is less than a threshold value, a product whose cumulative number of sales in POS data exceeds a threshold value, or a product that the product location management server 10 is notified of by the terminal device 30 of the employee 31 of the sales floor.

Next, the target product list manager 112 searches the database to specify the cart on which the target product is loaded and the area in which the cart is placed, and generates a target product list. The cart is specified by a board ID unique in the stockroom or a combination of the board ID and the area ID. The area where the cart is placed is specified by the area ID.

### (Management of Target Product List)

The target product list manager 112 deletes the product taken out from the cart by the employee 31 from the generated target product list. The target product list manager 112 subtracts the number of pieces of the product taken out from the cart by the employee 31 from the number of loaded boxes in the database stored in the database storage 104.

The area notifier 113 extracts information specifying one or more areas included in the target product list, and notifies the terminal device 30 of the extracted information specifying one or more areas.

The cart notifier 114 extracts information specifying one or more carts included in the target product list, and notifies the terminal device 30 of the extracted information specifying one or more carts.

The product notifier 115 extracts information specifying one or more products included in the target product list, and notifies the terminal device 30 of the extracted information specifying one or more products.

The database storage 104 stores the database registered by the register 103 in FIG. 6. The details are the same as those in FIG. 6, and thus the description thereof is omitted.

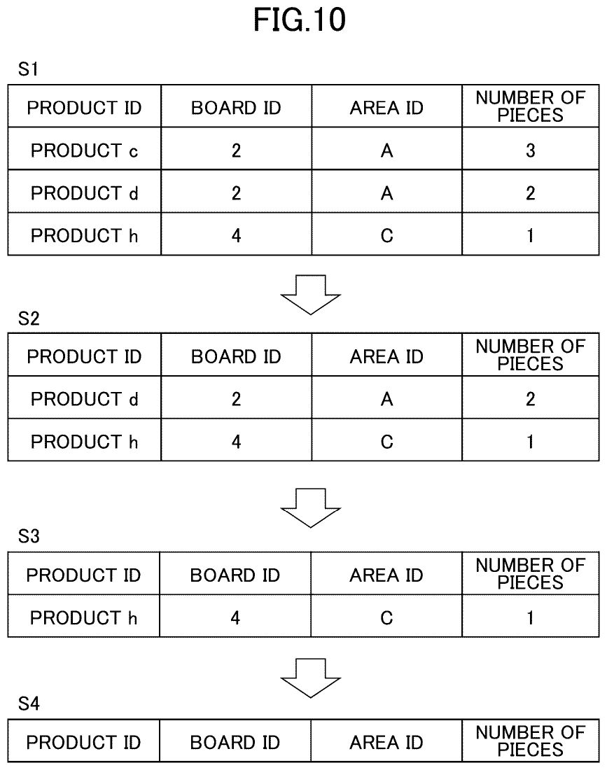

FIG. 10 is a transition diagram of a target product list according to an embodiment of the present disclosure.

Step 1 (S1) illustrates a target product list generated by the product location management server 10. The target product list may include information (product ID) for specifying each product to be supplied from the stockroom to the sales floor, information (board ID) for specifying a cart on which the product is loaded, information (area ID) for specifying an area in which the cart is placed, and the number of pieces of the product to be taken out from the cart. In S1, the target product list includes product c, product d, and product h.

Thereafter, when the employee 31 takes out product c from the cart, product c is deleted from the target product list as in step 2 (S2). As a result, the target product list includes product d and product h.

Thereafter, when the employee 31 takes out the product d from the cart, product d is deleted from the target product list as in step 3 (S3). As a result, the target product list includes product h.

Thereafter, when the employee 31 takes out product h from the cart, product h is deleted from the target product list as in step 4 (S4).

### <Method (Notification)>

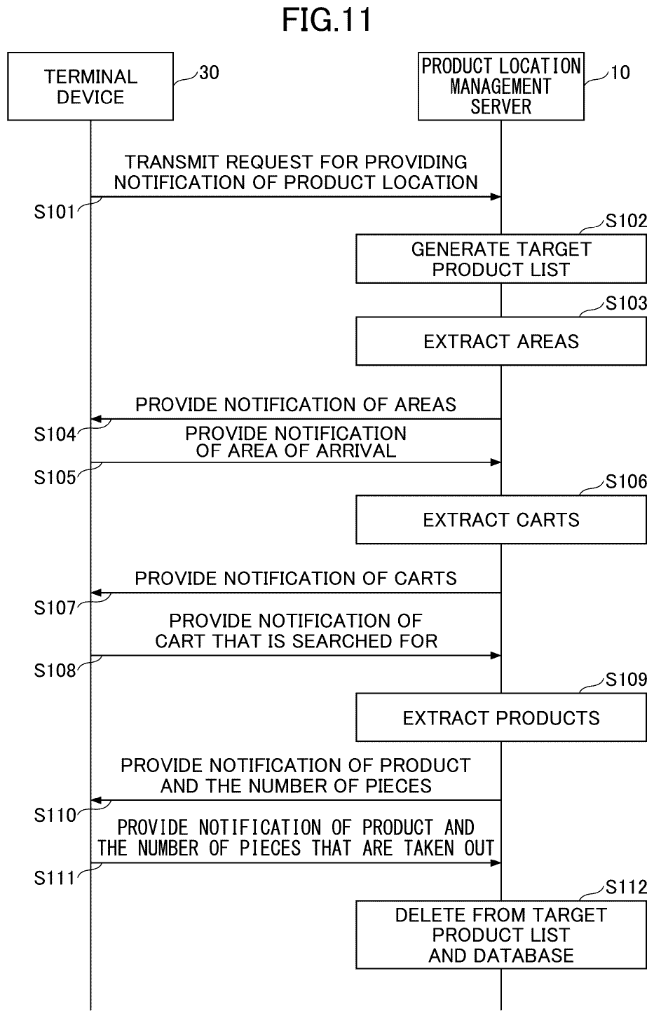

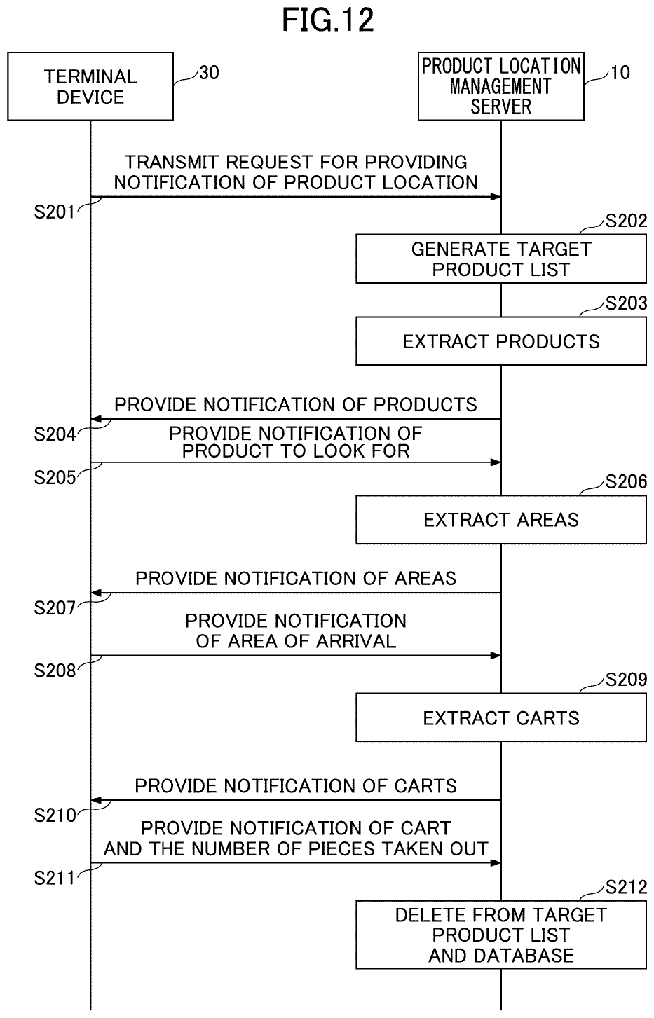

Hereinafter, a first embodiment of the process of notifying the employee 31 of a product location (in the case of searching by area) will be described with reference to FIG. 11, and a second embodiment of the process of notifying the employee 31 of a product location (in the case of searching by product) will be described with reference to FIG. 12. In the following embodiments described with reference to FIGS. 11 and 12, one terminal device 30 and the product location management server 10 communicate with each other to transmit and receive information (data) to perform the process. Alternatively, each of a plurality of terminal devices 30 and the product location management server may communicate with each other to transmit and receive information to perform the process. In this case, while a certain terminal device 30 is performing the process sequence of FIG. 11 or 12, another terminal device 30 may perform the process sequence of FIG. 11 or 12, and in these process sequences, the same database managed and stored by the product location management server 10 is referred to, and the employees who operate the respective terminal devices 30 can work simultaneously. In these process sequences, the operation result of each terminal device 30 is reflected in the database in real time, and each process sequence can immediately refer to the reflected result. In other words, during the process sequence of a first terminal device 30, the database can be updated by the process sequence of a second terminal device 30, and the updated database can be referred to by the process sequence of the first terminal device 30.

Both the first embodiment (searching by area) and the second embodiment (searching by product) may be implemented so that the employee 31 can specify the search criterion, or either one of the first embodiment (searching by area) or the second embodiment (searching by product) may be implemented.

### Embodiment 1

FIG. 11 is a sequence diagram of the process of notifying the employee 31 of a product location according to an embodiment of the present disclosure (Embodiment 1).

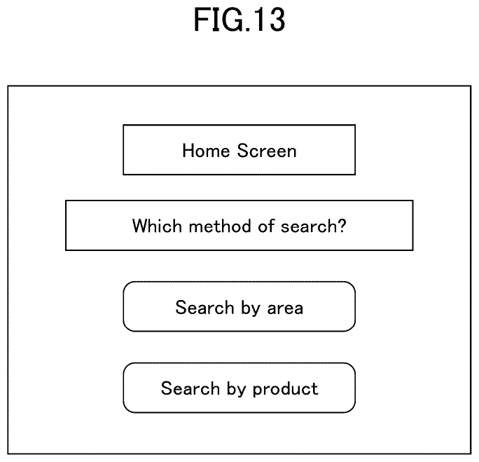

In step 101 (S101), the terminal device 30 transmits a request for notification of the location of a product to the product location management server 10. For example, when the employee 31 designates “Search by area” on the home screen of FIG. 13 displayed on the terminal device 30, the terminal device 30 receives an instruction to search for the product from the employee 31 and transmits a request for a notification of the location of the product to the product location management server 10.

In step 102 (S102), the product location management server 10 generates a target product list. Specifically, the product location management server 10 generates a target product list including information (product ID) for specifying each product to be supplied from the stockroom to the sales floor, information (board ID) for specifying the cart on which the product is loaded, and information (area ID) for specifying the area in which the cart is placed, by referring to the database stored in the database storage 104. The target product list includes the number of pieces of the product to be taken out from the cart for each product. The number of pieces of the product to be taken out may be determined in advance for each product, may be determined by the product location management server 10 in accordance with the situation of the sales floor at the time of receiving the request transmitted in S101, or may be determined by another criterion.

In step 103 (S103), the product location management server 10 extracts one or more areas (i.e., areas where the target product is present) included in the target product list generated in S102.

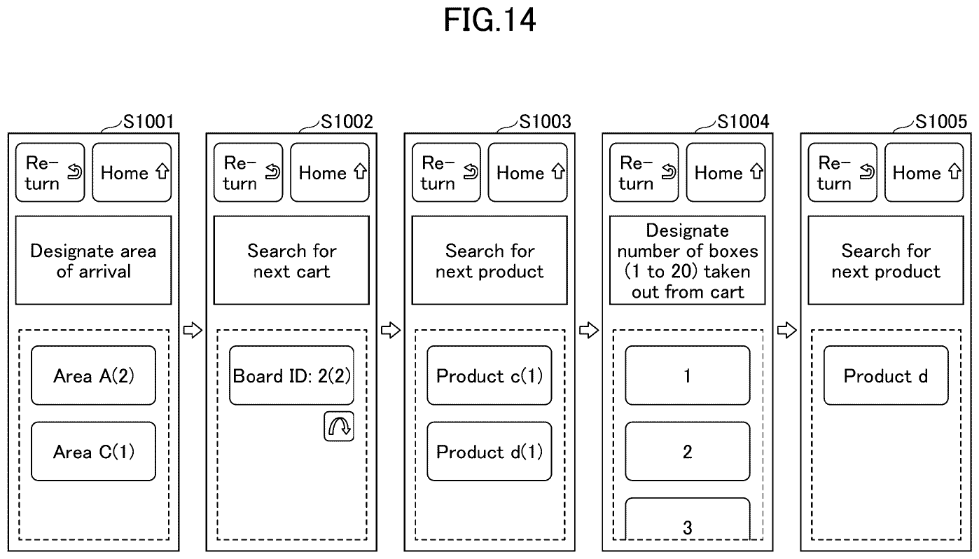

In step 104 (S104), the product location management server 10 notifies, as information used by the employee 31 to find the cart on which the target product (the product to search for) is loaded from the stockroom, the terminal device 30 of information specifying the areas extracted in S103 (for example, area IDs) associated with the carts, and notifies the terminal device 30 to move to any of the areas (for example, step 1001 in FIG. 14). In other words, the product location management server 10 notifies the terminal device 30 of information specifying an area where the cart on which the product to be searched for is loaded is placed and an instruction to move to the area. The terminal device 30 causes the display of the terminal device 30 to display these notifications.

For example, the product location management server 10 can cause the display of the terminal device 30 to display a plurality of areas in a descending order of the number of types of target product in an area. The display of the areas by the product location management server 10 is not limited to a descending order of the number of types of target product in an area, and the areas may be displayed in a descending order of a number of pieces of the target product in an area, in a descending order of the weight of the target product in an area, in a descending order of the size of the target product in an area, in a descending order of the urgency of supply of the target product in an area, or in a descending order of the area ID.

In step 105 (S105), the terminal device 30 notifies the product location management server 10 of the area where the employee 31 has moved and arrived among the areas that the employee 31 was notified of in S104. For example, when the employee 31 designates an area on the screen of step 1001 of FIG. 14 displayed on the terminal device 30, information (for example, an area ID) for specifying the area where the employee 31 has moved and arrived is transmitted from the terminal device 30 to the product location management server 10. In other words, the terminal device 30 notifies the product location management server 10 of content of the operation on the terminal device 30 that is input by the employee 31 in response to the notification in S104.

In step 106 (S106), the product location management server 10 extracts one or more carts (i.e., carts loaded with the target product) associated with the area that the employee 31 was notified of in S105 with reference to the target product list generated in S102.

In step 107 (S107), the product location management server 10 notifies, as information used by the employee 31 to search the stockroom for the cart on which the target product (the product to search for) is loaded, the terminal device 30 of information specifying the carts extracted in S106 (for example, board IDs) associated with the carts, and notifies the terminal device 30 to find any of the carts (for example, step 1002 in FIG. 14). In other words, after the terminal device 30 is operated in response to the notification made in S104, the product location management server 10 notifies the terminal device 30 of information specifying the cart on which the product to be searched for is loaded and an instruction to find the cart. The terminal device 30 causes the display of the terminal device 30 to display these notifications.

For example, the product location management server 10 can cause the display of the terminal device 30 to display a plurality of carts in a descending order of the number of types of target product in a cart. The display of the carts by the product location management server 10 is not limited to a descending order of the number of types of target products in a cart, and the carts may be displayed in a descending order of a number of pieces of the target product in a cart, in a descending order of the weight of the target product in a cart, in a descending order of the size of the target product in a cart, in a descending order of the urgency of supply of the target product in a cart, in a descending order of accessibility of a cart, or in order of a cart ID.

In step 108 (S108), the terminal device 30 notifies the product location management server 10 of the cart that the employee 31 has found in the area among the carts in S107. For example, when the employee 31 designates a cart on the screen of step 1002 of FIG. 14 displayed on the terminal device 30, information (for example, a board ID) for specifying the cart that the employee 31 has searched for in an area is transmitted from the terminal device 30 to the product location management server 10. In other words, the terminal device 30 notifies the product location management server 10 of content of the operation on the terminal device 30 that is input by the employee 31 in response to the notification in S107.

In step 109 (S109), the product location management server 10 extracts one or more target products associated with the cart that the employee 31 was notified of in S108 with reference to the target product list generated in S102.

In step 110 (S110), the product location management server 10 notifies the terminal device 30 of information specifying the target product extracted in S109 and the number of pieces of the product to be taken out from the cart, and notifies the terminal device 30 to search for the product (for example, step 1003 in FIG. 14). In other words, after the terminal device 30 is operated in response to the notification of S107, the product location management server 10 notifies the terminal device 30 of information specifying the product to be searched for in the cart and an instruction to search for the product and take out a necessary number of the products from the cart. The terminal device 30 causes the display of the terminal device 30 to display these notifications.

The employee 31 may determine the number of pieces (for example, take out one container), without receiving a notification of the number of pieces from the product location management server 10.

For example, the product location management server 10 may cause the display of the terminal device 30 to display the plurality of target products in a descending order of the number of pieces of a product to be taken out, in a descending order of the weight of a product, in a descending order of the size of a product, in a descending order of the degree of urgency of supply of a product, or in order of a product name.

In step 111 (S111), the terminal device 30 notifies the product location management server 10 of the target product taken out from the cart by the employee 31 among the products that the employee was notified of in S110 and the number of pieces of the product. For example, when the employee 31 designates the product and the number of pieces of the product on the screens of steps 1003 and 1004 of FIG. 14 displayed on the terminal device 30, information (for example, product ID) for specifying the product taken out by the employee 31 and the number of pieces of the product are transmitted from the terminal device 30 to the product location management server 10.

In step 112 (S112), the product location management server 10 deletes the record of the target product taken out from the cart by the employee 31 in S102 from the target product list generated in S111. The product location management server 10 subtracts, in the database stored in the database storage 104, the number of pieces of the product taken out from the cart by the employee 31 in S111. In other words, the product location management server 10 updates the number of loaded boxes in the database so as to be decreased by the number that the employee 31 was notified of in S111, for the product notified in S111 loaded on the cart that the employee 31 was notified of in S108 placed in the area that the employee 31 was notified of in S105. Then, the process returns to S110 in the case where there is still a product to be taken out from the cart, returns to S107 in the case where there is still a product to be taken out from the area, and returns to S104 in the case where there is no product to be taken out from the area.

The product location management server 10 may transmit the target product list generated in S102 to the terminal device 30, and the terminal device 30 may perform S103 through S112.

### Embodiment 2

FIG. 12 is a sequence diagram of the process of notifying the employee 31 of a product location according to an embodiment of the present disclosure (Embodiment 2).

In step 201 (S201), the terminal device 30 transmits a request for notification of the location of a product to the product location management server 10. For example, when the employee 31 designates “Search by product” on the home screen of FIG. 13 displayed on the terminal device 30, the terminal device 30 receives an instruction to search for the product from the employee 31 and transmits a request for a notification of the location of the product to the product location management server 10.

Step 202 (S202) is the same process as the above-described step 102.

In step 203 (S203), the product location management server 10 extracts one or more products included in the target product list generated in S202.

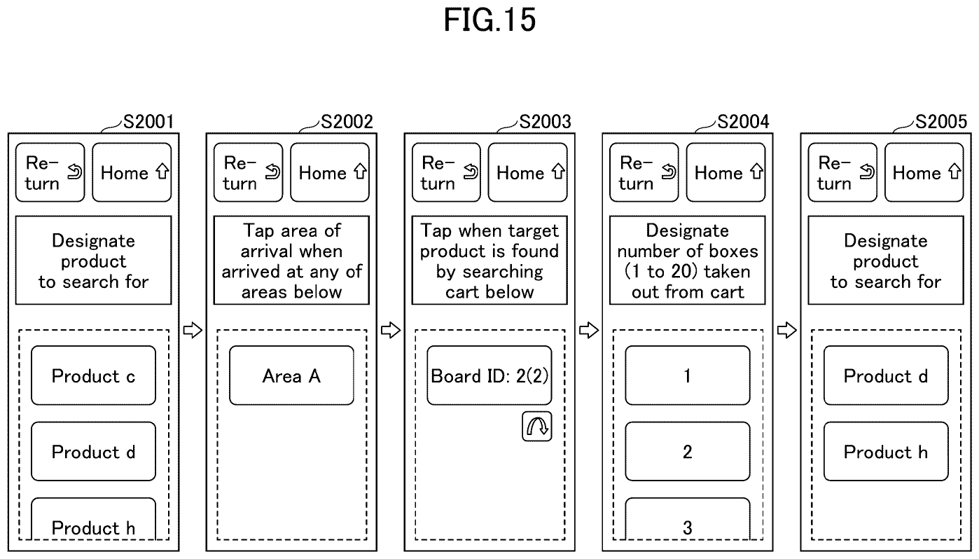

In step 204 (S204), the product location management server 10 notifies the terminal device 30 of information (for example, product IDs) for specifying the products extracted in S203, and notifies the terminal device 30 to designate any one of the products (for example, step 2001 in FIG. 15). In other words, the product location management server 10 notifies the terminal device 30 of information specifying the product to be searched for and an instruction for designating the product. The terminal device 30 causes the display of the terminal device 30 to display these notifications.

For example, the product location management server 10 may cause the display of the terminal device 30 to display a plurality of target products in a descending order of the number of pieces of a product, in a descending order of the weight of a product, in a descending order of the size of a product, in a descending order of the degree of urgency of supply of a product, or in order of a product name.

In step 205 (S205), the terminal device 30 notifies the product location management server 10 of the product that the employee 31 is searching for among the products designated in S204. For example, when the employee 31 designates the product on the screen of step 2001 of FIG. 15 displayed on the terminal device 30, information (for example, product ID) for specifying the product that the employee 31 is searching for is transmitted from the terminal device 30 to the product location management server 10. In other words, the terminal device 30 notifies the product location management server 10 of content of the operation on the terminal device 30 that is input by the employee 31 in response to the notification in S204.

In step 206 (S206), the product location management server 10 extracts one or more areas (i.e., areas where the target product is) associated with the area notified that the employee 31 was notified of in S205 with reference to the target product list generated in S202.

In step 207 (S207), the product location management server 10 notifies, as information used by the employee 31 to find the cart on which the target product (the product to search for) is loaded from the stockroom, the terminal device 30 of information specifying the areas extracted in S206 (for example, area IDs) associated with the carts, and notifies the terminal device 30 to move to any of the areas (for example, step 2002 in FIG. 15). In other words, after the terminal device 30 is operated in response to the notification made in S204, the product location management server 10 notifies the terminal device 30 of information specifying an area where the cart on which the product to be searched for is loaded is placed and an instruction to move to the area. The terminal device 30 causes the display of the terminal device 30 to display these notifications.

For example, the product location management server 10 can cause the display of the terminal device 30 to display a plurality of areas in a descending order of the number of types of target product in an area. The display of the areas by the product location management server 10 is not limited to a descending order of the number of types of target product in an area, and the areas may be displayed in a descending order of a number of pieces of a target product in an area, in a descending order of the weight of a target product in an area, in a descending order of the size of a target product in an area, in a descending order of the urgency of supply of a target product in an area, or in order of an area ID.

In step 208 (S208), the terminal device 30 notifies the product location management server 10 of the area where the employee 31 has moved and arrived among the areas that the employee 31 was notified of in S207. For example, when the employee 31 designates an area on the screen of step 2002 of FIG. 15 displayed on the terminal device 30, information (for example, an area ID) for specifying the area where the employee 31 has moved and arrived is transmitted from the terminal device 30 to the product location management server 10. In other words, the terminal device 30 notifies the product location management server 10 of content of the operation on the terminal device 30 that is input by the employee 31 in response to the notification in S207.

In step 209 (S209), the product location management server 10 extracts one or more carts (i.e., carts carrying the target product) associated with the area notified that the employee 31 was notified of in S208 with reference to the target product list generated in S202.

In step 210 (S210), the product location management server 10 notifies, as information used by the employee 31 to find the cart on which the target product (the product to search for) is loaded from the stockroom, the terminal device 30 of information specifying the carts extracted in S209 (for example, board IDs) associated with the cart and the number of pieces of the product designated in S205 to be taken out from the cart, and notifies the terminal device 30 to find any of the carts (for example, step 2003 in FIG. 15). In other words, after the terminal device 30 is operated in response to the notification made in S207, the product location management server 10 notifies the terminal device 30 of information specifying the cart on which the product to be searched for is loaded and an instruction to find the cart and to take out the necessary number of pieces of the product. The terminal device 30 causes the display of the terminal device 30 to display these notifications.

For example, the product location management server 10 can cause the display of the terminal device 30 to display a plurality of carts in a descending order of the number of types of target product in a cart. The display of the carts by the product location management server 10 is not limited to a descending order of the number of types of target product in a cart, and the carts may be displayed in a descending order of a number of pieces of a target product in a cart, in a descending order of a weight of a target product in a cart, in a descending order of a size of a target product in a cart, in a descending order of the urgency of supply of a target product in a cart, or in order of the cart ID.

The employee 31 may determine the number of pieces (for example, take out one container), without receiving a notification of the number of pieces from the product location management server 10.

In step 211 (S211), the terminal device 30 notifies the product location management server 10 of the cart from which the employee 31 has taken out the product and the number of pieces of the product taken out from the cart (i.e., the product designated in S205). For example, when the employee 31 taps a cart on the screen of step 2003 of FIG. 15 displayed on the terminal device 30 and specifies the number of pieces on the screen of step 2004, the cart from which the employee 31 has taken out the product and the number of pieces of the product taken out from the cart are transmitted from the terminal device 30 to the product location management server 10.

In step 212 (S212), the product location management server 10 deletes the record of the product taken out from the cart by the employee 31 in S202 from the target product list generated in S211. The product location management server 10 subtracts, in the database stored in the database storage 104, the number of pieces of the product taken out from the cart by the employee 31 in S211 from the number of pieces loaded on the cart from which the product is taken out. In other words, the product location management server 10 updates the number of loaded boxes in the database so as to be decreased by the number that the employee 31 was notified of in S211, for the product that the employee 31 was notified of in S205 loaded on the cart notified in S211 placed in the area that the employee 31 was notified of in S208.

### <Screen>

Hereinafter, a screen displayed on the display of the terminal device 30 by the terminal device 30 will be described with reference to FIGS. 13 through 15. The information designated on the display of the terminal device 30 is provided (transmitted) from the terminal device 30 to the product location management server 10 and processed by the product location management server 10. When the product location management server 10 notifies (transmits to) the terminal device 30 of the screen information as the processing result to the terminal device 30, the terminal device 30 displays a screen based on the screen information.

FIG. 13 is an example of a home screen (the first screen when a notification of a product location is provided) displayed on the terminal device 30 according to an embodiment of the present disclosure. For example, when the employee 31 operates the terminal device 30 to activate an application program for notifying the employee 31 of a product location, the terminal device 30 displays a home screen like the one illustrated in FIG. 13. The home screen shows a method with which the employee 31 searches for the product location (for example, both “Search by area” and “Search by product” may be shown as illustrated in FIG. 13, or only one of them (only “Search by area” or only “Search by product”) may be shown). The employee 31 can designate a method of searching for the product location on the home screen. In the case where there is only one of the methods for searching for a product location, the home screen need not be displayed, and the terminal device 30 may display the first screen of the corresponding method.

### Embodiment 1

FIG. 14 is a transition diagram of a screen displayed on the terminal device 30 according to an embodiment of the present disclosure (Embodiment 1). When “Search by area” is specified on the home screen of FIG. 13, a screen of step 1001 is displayed.

In step 1001 (S1001), information specifying one or more areas included in a target product list is displayed. The number of types of target product in the area may be also displayed for each area, together with the information specifying the area. In the screen illustrated in S1001, the number of types of target product is indicated in parentheses.

The employee 31 searches at the screen illustrated in S1001 and moves to any one of the areas displayed on the screen illustrated in S1001. Then, the employee 31 designates the area where the employee 31 has moved and arrived on the screen of S1001.

In step 1002 (S1002), information specifying one or a plurality of carts associated with the area designated in S1001 in the target product list is displayed. For each cart, the number of types of target product in the cart may be displayed together with the information specifying the cart. In the screen illustrated in S1002, the number of types of target product is indicated in parentheses.

The employee 31 searches at the screen of S1002 and searches for any one of the carts displayed on the screen of S1002 in the area. Then, the employee 31 specifies the cart that the employee 31 has found by searching in the area on the screen of S1002.

The screen for designating the cart of S1002 may include the “Search later” button for each cart (a button for indicating that the employee is not going to take out the target product from the cart for now). When the “Search later” button represented by the arrow displayed near the information specifying the cart is designated on the screen of S1002, the terminal device 30 notifies the product location management server 10 of the designation, and the product location management server 10 estimates that the cart of the board ID (for example, 2 in the example of FIG. 14) corresponding to the “Search later” button is located at a position where the employee 31 has difficulty in accessing, and lowers the order of the board ID in the next round of display.

In step 1003 (S1003), information specifying one or a plurality of target products associated with the cart designated in S1002 in the target product list is displayed. For example, the number of pieces of each target product to be taken out from the cart may also be displayed. On the screen of S1003, the number of pieces to be taken out is indicated in parentheses.

The employee 31 takes out the target product from the cart while looking at the screen of S1003. Then, the employee 31 specifies the target product taken out from the cart by the employee 31 on the screen of S1003.

The screen for designating the target product in S1003 may include the “Not found” button for each product (the button for indicating that the employee is not able to find the target product in the cart). When the “Not found” button is designated, the terminal device 30 notifies the product location management server 10 of the designation, and the product location management server 10 assumes that the target product corresponding to the “Not found” button (e.g., product c in the example of FIG. 14) is not present in the area and cart designated on the screens of S1001 and S1002, respectively, and deletes (clears) the record of product c associated with the area and cart and managed in the database.

In step 1004 (S1004), a screen for designating the number of pieces taken out from the cart by the employee 31 is displayed.

The employee 31 specifies the number of pieces of the product in S1003 that the employee 31 has taken out from the cart on the screen of S1004.

The terminal device 30 notifies the product location management server 10 of information on which product and how many pieces of the product have been taken out in S1003 and S1004.

Thereafter, in the case where another target product is loaded on the current cart (the cart designated in S1002), the screen of step 1005 is displayed.

In step 1005 (S1005), information specifying another target product loaded on the current cart (the cart designated in S1002) is displayed. When the employee 31 specifies the next product to be searched for, a screen for specifying the number of pieces of the product that have been taken out from the cart is displayed like the screen illustrated in S1004. On the other hand, in the case where there is no target product to be displayed on the screen of S1005 (in the case where the target product is not loaded on the current cart), in the case where there is a cart loaded with another target product in the current area, the screen returns to the screen for designating another cart in the current area, such as the screen of S1002, and in the case where there is no cart loaded with the target product in the current area, the screen returns to the screen for designating another area, such as the screen of S1001.

When the “Return” button of each screen is designated, the screen returns to the previous display, and when the “Home” button is designated, the home screen is displayed. Each screen can be scrolled in the vertical direction by a swipe operation or the like.

### Embodiment 2

FIG. 15 is a transition diagram of a screen displayed on the terminal device 30 according to an embodiment of the present disclosure (Embodiment 2). When “Search by product” is specified on the home screen of FIG. 13, the screen of step 2001 is displayed.

In step 2001 (S2001), information specifying one or more products included in a target product list is displayed.

The employee 31 specifies a product that the employee 31 wants to search for on the screen of S2001. The employee 31 may designate a product to be searched for by a product name, a GTIN (JAN code), or the like.

In step 2002 (S2002), information specifying one or a plurality of areas associated with the product designated in S2001 in the target product list is displayed.

The employee 31 searches at the screen illustrated in S2002 and moves to any one of the areas displayed on the screen illustrated in S2002. Then, the employee 31 designates the area where the employee 31 has moved and arrived on the screen of S2002.

In step 2003 (S2003), information specifying one or a plurality of carts associated with the area designated in S2002 in the target product list is displayed. For example, the number of pieces to be taken out from the cart may also be displayed.

The employee 31 searches at the screen of S2003 and searches for any one of the carts displayed on the screen of S2003 in the area. Then, the employee 31 specifies the cart that the employee 31 has searched for in the area on the screen of S2003.

The screen of S2003 for designating the cart may include the “Search later” button for each cart, as in the screen of S1002 in FIG. 14.

In step 2004 (S2004), a screen for designating the number of pieces taken out from the cart by the employee 31 is displayed.

The employee 31 takes out the product from the cart and designates the number of pieces of the product taken out from the cart by the employee 31 on the screen of S2004.

Thereafter, in the case where the next product is searched for, the screen of step 2005 is displayed. This screen corresponds to the screen of S2001 from which the product designated on the screen of S2001 is excluded.

In step 2005 (S2005), information specifying the product to be searched for next is displayed. When the employee 31 specifies the next product to be searched for, the screen returns to the screen for specifying an area such as the screen of S2002.

When the “Return” button of each screen is designated, the screen returns to the previous display, and when the “Home” button is designated, the home screen is displayed. Each screen can be scrolled in the vertical direction by a swipe operation or the like.

### <Estimation of Accessibility to Product>

In an embodiment of the present disclosure, the product location management server 10 can estimate the ease of access to a product (namely, the degree to which the employee 31 can easily take out a product). Specifically, the product location management server 10 can estimate the ease of access to the product based on the history of the employee 31 not taking the product out of the cart and the history of the employee 31 taking the product out of the cart (for example, the history of the “Search later” button being designated, the history of the cart (board ID) not being designated, the history of the cart (board ID) being designated, and the like). The product location management server 10 can determine the display order of the carts (board IDs) based on the estimated ease of access to the products. Therefore, the display order of the cart which is assumed to be difficult to take out the product among the carts in the area is lowered, and the display order of the cart which is assumed to be loaded with the product at the position which is difficult to take out in the cart is lowered, and thus it is possible to present the cart (board ID) having high easiness of access to the product to the employee 31 at a high display order.

### <Effects>

As described above, in the embodiment of the present disclosure, in consideration of the fact that inventory products are loaded on carts and managed in a stockroom, a database in which attributes of area, cart, and product are interrelated is built and designed to be configurable with granularity of area, cart, and product.

In the above-described embodiment, it has been described that the present system can be applied to a case where an employee searches for a product to be supplied to a sales floor from a plurality of carts placed in each area of a stockroom in a store in which the sales floor for selling products and the stockroom for storing products are separated. However, the present system can also be applied to a case where a customer searches for a target product that the customer wants to purchase from a plurality of carts placed in each area in the store. In this case, the store integrally includes a sales floor for selling the products and a stockroom for storing the products, and the stockroom itself is the sales floor. In such a store, a customer (user) who searches for a target product carries the terminal device 30 and requests a target product from the product location management server 10 via the terminal device 30. The product location management server 10 notifies the terminal device 30 carried by the customer of information specifying a cart on which the target product is loaded. Thus, the customer can efficiently find the target product.

### <Hardware Configuration>

A part or all of the devices (the product location management server 10, the delivery center management server 20, and the terminal device 30) in the above-described embodiment may be configured by hardware, or may be configured by information processing of software (program) executed by a central processing unit (CPU), a graphics processing unit (GPU), or the like. In the case where the information processing is performed by software, software for realizing at least a part of the functions of the devices in the above-described embodiments may be stored in a non-transitory storage medium (non-transitory computer-readable medium) such as a compact disc read only memory (CD-ROM) or a universal serial bus (USB) memory, and a computer may read the software to perform the information processing of the software. The software may be downloaded via a communication network. Furthermore, all or some of the processes of software may be implemented in a circuit such as an application specific integrated circuit (ASIC) or a field programmable gate array (FPGA), and information processing by the software may be executed by hardware.

The storage medium for storing the software may be a removable medium such as an optical disk, or a fixed storage medium such as a hard disk or a memory. The storage medium may be provided inside the computer (a main storage device, an auxiliary storage device, or the like) or may be provided outside the computer.

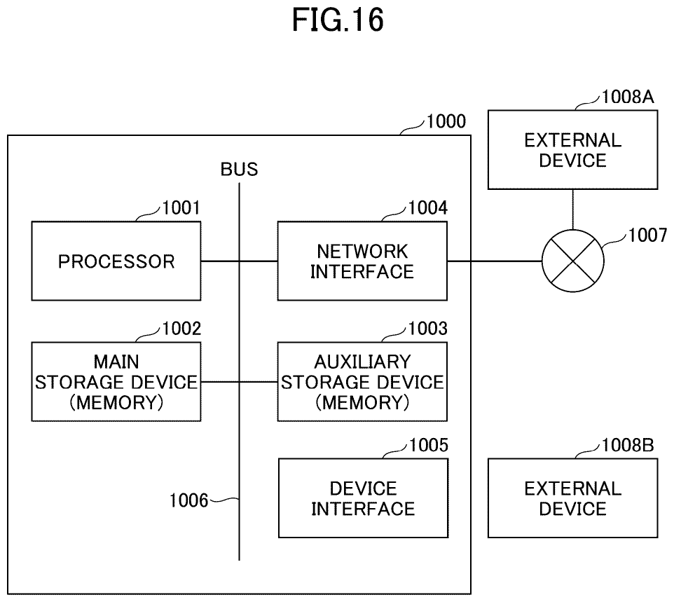

FIG. 16 is a block diagram illustrating an example of a hardware configuration of each device (the product location management server 10, the delivery center management server 20, and the terminal device 30) in the above-described embodiment. Each device may be implemented as a computer 1000 that includes a processor 1001, a main storage device 1002 (memory), an auxiliary storage device 1003 (memory), a network interface 1004, and a device interface 1005, which are connected via a bus 1006, for example.

The computer 1000 of FIG. 16 includes one of each component, but may include a plurality of the same components. Although FIG. 16 illustrates one computer 1000, the software may be installed in a plurality of computers, and the plurality of computers may execute the same or different partial processing of the software. In this case, the computers may be in a distributed computing form in which the computers communicate with each other via the network interface 1004 or the like to execute the processing. In other words, each device (the product location management server 10, the delivery center management server 20, and the terminal device 30) in the above-described embodiment may be configured as a system that realizes a function by one or more computers executing instructions stored in one or more storage devices. The information transmitted from the terminal may be processed by one or more computers provided on the cloud, and the processing result may be transmitted to the terminal.

Various calculations of the respective devices (the product location management server 10, the delivery center management server 20, and the terminal device 30) in the above-described embodiment may be executed by parallel processing using one or a plurality of processors or using a plurality of computers connected via a network. Various operations may be distributed to a plurality of operation cores in the processor and executed by parallel processing. In addition, a part or all of the processes, means, and the like of the present disclosure may be realized by at least one of a processor and a storage device provided on a cloud capable of communicating with the computer 1000 via a network. As described above, each device in the above-described embodiments may be in a form of parallel computing by one or more computers.

The processor 1001 may be an electronic circuit (a processing circuit, processing circuitry, a CPU, a GPU, an FPGA, an ASIC, or the like) that performs at least one of control and calculation of a computer. The processor 1001 may be any of a general-purpose processor, a dedicated processing circuit designed to execute a specific operation, or a semiconductor device including both a general-purpose processor and a dedicated processing circuit. The processor 1001 may include an optical circuit or may include a calculation function based on quantum computing.

The processor 1001 may perform arithmetic processing based on data or software that is input from each device or the like of the internal configuration of the computer 1000, and may output an arithmetic result or a control signal to each device or the like. The processor 1001 may control each component constituting the computer 1000 by executing an operating system (OS), an application, or the like of the computer 1000.

Each device (the product location management server 10, the delivery center management server 20, and the terminal device 30) in the above-described embodiment may be realized by one or a plurality of processors 1001. Herein, the processor 1001 may refer to one or more electronic circuits disposed on one chip, or may refer to one or more electronic circuits arranged on two or more chips or two or more devices. In the case where a plurality of electronic circuits are used, the electronic circuits may communicate with each other in a wired or wireless manner.

The main storage device 1002 may store instructions executed by the processor 1001, various data, and the like, and information stored in the main storage device 1002 may be read by the processor 1001. The auxiliary storage device 1003 is a storage device other than the main storage device 1002. These storage devices mean discretionarily selected electronic components capable of storing electronic information, and may be semiconductor memories. The semiconductor memory may be either a volatile memory or a nonvolatile memory. The storage device for storing various data and the like in each device (the product location management server 10, the delivery center management server 20, and the terminal device 30) in the above-described embodiment may be realized by the main storage device 1002 or the auxiliary storage device 1003, or may be realized by an internal memory built in the processor 1001. For example, the storage in the above-described embodiment may be realized by the main storage device 1002 or the auxiliary storage device 1003.

In the case where each device (the product location management server 10, the delivery center management server 20, and the terminal device 30) in the above-described embodiment is configured by at least one storage device (memory) and at least one processor connected (coupled) to the at least one storage device, the at least one processor may be connected to one storage device. At least one storage device may be connected to one processor. The configuration may include a configuration in which at least one processor of the plurality of processors is connected to at least one storage device of the plurality of storage devices. This configuration may be realized by a storage device and a processor included in a plurality of computers. Furthermore, the storage device may be integrated with the processor (for example, a L1 cache or a cache memory including a L2 cache).

The network interface 1004 is an interface for connecting to the communication network 1007 in a wireless or wired manner. The network interface 1004 may be an appropriate interface such as an interface conforming to an existing communication standard. The network interface 1004 may exchange information with an external device 1008A connected via the communication network 1007. The communication network 1007 may be any one of a wide area network (WAN), a local area network (LAN), a personal area network (PAN), and the like, or a combination thereof, and may be any network as long as information is exchanged between the computer 1000 and the external device 1008A. Examples of WANs include the Internet, etc., examples of LANs include IEEE 802.11 and Ethernet (registered trademark), etc., and examples of the PAN include Bluetooth (registered trademark) and near field communication (NFC).

The interface 1005 is an interface such as a universal serial bus (USB) that directly connects to the external apparatus 1008B.

The external apparatus 1008A is an apparatus connected to the computer 1000 via a network. The external device 1008B is a device directly connected to the computer 1000.

The external device 1008A or the external device 1008B may be an input device, for example. The input device is a device such as a camera, a microphone, a motion capture camera, various sensors, a keyboard, a mouse, or a touch panel, and provides the computer 1000 with acquired information. The information processing apparatus may be a device including an inputter, a memory, and a processor, such as a personal computer, a tablet terminal, or a smartphone.

The external device 1008A or the external device 1008B may be an outputting device, for example. The output device may be, for example, a display device such as a liquid crystal display (LCD) or an organic electro luminescence (EL) panel, or may be a speaker or the like that outputs sound or the like. The information processing apparatus may be a device including an outputter, a memory, and a processor, such as a personal computer, a tablet terminal, or a smartphone.

The external device 1008A or the external device 1008B may be a storage device (memory). For example, the external device 1008A may be a network storage or the like, and the external device 1008B may be a storage such as an HDD.

The external device 1008A or the external device 1008B may be a device having a function of a part of the components of the devices (the product location management server 10, the delivery center management server 20, and the terminal device 30) in the above-described embodiment. In other words, the computer 1000 may transmit a part or all of the processing result to the external device 1008A or the external device 1008B, or may receive a part or all of the processing result from the external device 1008A or the external device 1008B.

In the present specification (including the claims), in the case where the expression “at least one of a, b, and c” or “at least one of a, b, or c” is used (including similar expressions), any one of a, b, c, a−b, a−c, b−c, or a−b−c is included. Multiple instances may also be included in any of the elements, such as a−a, a−b−b, and a−a−b−b−c−c. Further, the addition of another element other than the listed elements (a, b, and c), such as adding d as a−b−c−d, is included.

In the present specification (including the claims), in the case where the expression such as “data as an input”, “based on data”, “according to data”, or “in accordance with data” (including similar expressions) is used, unless otherwise indicated, a case where data is used and a case where data obtained by processing various data (for example, data obtained by adding noise, normalized data, feature extracted from data, and intermediate representation of data) is used as an input are included. In addition, in the case where it is described that some result is obtained “using data as input/based on/according to/in response to” (including similar expressions), unless otherwise specified, the case where the result is obtained based on only the data, and the case where the result is obtained by being influenced by data other than the data, a factor, a condition, and/or a state are included. If it is described that “data is output”, unless otherwise indicated, a case where various data is used as an output and a case where data processed in some way (for example, data obtained by adding noise, normalized data, feature extracted from data, and intermediate representation data) is used as an output are included.

In the present specification (including the claims), in the case where the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), in the case where the expression “A configured to B” is used, a case where a physical structure of the element A has a configuration that can perform the operation B, and a permanent or temporary setting/configuration of the element A is configured/set to actually perform the operation B may be included. For example, in the case where the element A is a general-purpose processor, the processor may have a hardware configuration that can perform the operation B and be configured to actually perform the operation B by setting a permanent or temporary program (instruction). In the case where the element A is a dedicated processor, a dedicated arithmetic circuit, or the like, a circuit structure, etc. of the processor may be implemented so as to actually perform the operation B irrespective of whether or not the control instruction and the data are actually attached.

In the present specification (including the claims), in the case where a term indicating containing or possessing (for example, “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (an expression using “a” or “an” as an article), the expression should be interpreted as being not limited to a specified number.

In the present specification (including the claims), even in the case where an expression such as “one or more” or “at least one” is used in a certain description, and an expression that does not specify a quantity or that suggests a singular number is used in another description (an expression using “a” or “an” as an article), it is not intended that the latter expression indicates “one”. Generally, an expression that does not specify a quantity or that suggests a singular number (that is, an expression using “a” or “an” as an article) should be interpreted as being not necessarily limited to a particular number.

In the present specification, in the case where it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, and/or states are satisfied, and is not necessarily obtained in the claimed invention that defines the configuration or a similar configuration.

In the present specification (including the claims), in the case where multiple hardware performs predetermined processes, each of the hardware may cooperate to perform the predetermined processes, or some of the hardware may perform all of the predetermined processes. Additionally, some of the hardware may perform some of the predetermined processes while another hardware may perform the remainder of the predetermined processes. In the present specification (including the claims), in the case where an expression such as “one or more hardware performs a first process and the one or more hardware perform a second process” (or a similar expression) is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), in the case where multiple storage devices (memories) store data, each of the multiple storage devices (memories) may store only a portion of the data or may store an entirety of the data. Further, a configuration in which some of the plurality of storage devices store data may be included.

Although the embodiments of the present disclosure have been described above in detail, the present disclosure is not limited to the individual embodiments described above. Various additions, modifications, substitutions, partial deletions, and the like may be made without departing from the conceptual idea and spirit of the invention derived from the contents defined in the claims and the equivalents thereof. For example, in the above-described embodiments, in the cases where numerical values or mathematical expressions are used for description, they are shown for illustrative purposes and do not limit the scope of the present disclosure. The order of the operations described in the embodiment is also exemplary and does not limit the scope of the present disclosure.

What is claimed is:

1. A system for managing locations of products, comprising:
one or more memories; and
one or more processors configured to:
read an information medium attached to a storage unit loaded with at least one first product, the storage unit being located in a stockroom in a retail store having a sales floor;
associate the first product loaded on the storage unit located in the stockroom and a location in the stockroom with each other, using information acquired from reading the information medium attached to the storage unit; and
notify a terminal device of the location in the stockroom associated with the first product when the stockroom is searched for the first product with the terminal device.

2. The system according to claim 1, wherein
the notified location in the stockroom indicates at least an area where a plurality of storage units including the storage unit are located in the stockroom and the information medium attached to the storage unit loaded with the first product.

3. The system according to claim 1, wherein
the information acquired from reading the information medium includes area identification information identifying an area in the stockroom, the information medium being attached to the storage unit located at the area, and
the one or more processors are configured to:
associate the area identified by the area identification information as the location in the stockroom, with the first product loaded on the storage unit located at the area; and
notify the terminal device of the area as the location in the stockroom associated with the first product.

4. The system according to claim 2, wherein
the information acquired from reading the information medium includes medium identification information identifying the information medium, and
the one or more processors are configured to:
associate the information medium identified by the medium identification information as the location in the stockroom, with the first product loaded on the storage unit that is located with the information medium in the stockroom; and
notify the terminal device of the area and the information medium as the location in the stockroom associated with the first product loaded on the storage unit that is located with the information medium at the area in the stockroom.

5. The system according to claim 1, wherein
the storage unit loaded with the first product is delivered from a delivery center to the stockroom in the retail store, and
the one or more processors are configured to:
acquire delivery information that associates the storage unit delivered from the delivery center to the stockroom with the first product delivered from the delivery center while being loaded on the storage unit; and
associate the first product loaded on the storage unit located in the stockroom and the location in the stockroom with each other, using the information acquired from reading the information medium attached to the storage unit and the acquired delivery information.

6. The system according to claim 1, wherein
the one or more processors are configured to:
generate a database by the association of the first product and the location in the stockroom; and
notify the location in the stockroom by referring to the database that associates the first product and the location in the stockroom with each other.

7. The system according to claim 6, wherein
the one or more processors are configured to generate the database based on (i) an acceptance list indicating which products loaded on which storage units when delivered from a delivery center to the stockroom in the retail store, (ii) identifiers identifying respective storage units loaded with products, and (iii) each information acquired by reading information media attached to the respective storage units.

8. The system according to claim 1, wherein
the storage unit is a wheeled stockroom cart, and the location in the stockroom indicates a location in the stockroom to which the wheeled stockroom cart loaded with the first product is moved.

9. The system according to claim 1, wherein
the one or more processors are configured to:
manage a number of containers loaded on the storage unit, each of the containers being packed with a group of the first product; and
update, when one or more of the containers are taken out from the storage unit, the number of containers by subtracting a number of taken containers.

10. The system according to claim 1, wherein
the storage unit is loaded with one or more containers packed with a group of the first product, and
the one or more processors are configured to notify the terminal device of a number of containers to be taken out from the storage unit.

11. The system according to claim 1, wherein
the one or more processors are configured to notify, when a plurality of products for which the stockroom is searched are in the location in the stockroom, the terminal device of a number of the plurality of products associated with the location in the stockroom.

12. The system according to claim 1, wherein
the one or more processors are configured to notify, when a plurality of products for which the stockroom is searched are loaded on a plurality of storage units located in different locations, the terminal device of the different locations in a descending order of a number of products being searched for in each of the different locations.

13. The system according to claim 1, wherein
a group of the first product is packed in a container, and the container is loaded on the storage unit.

14. The system according to claim 1, wherein
a plurality of types of product are loaded on the storage unit.

15. The system according to claim 1, wherein
the information medium attached to the storage unit displays location information by one or more human-recognizable characters or a human-recognizable color, the location information indicating a predetermined location being used as the location in the stockroom.

16. The system according to claim 15, wherein
the information medium attached to the storage unit displays a code coding the information, the code being read to acquire the information, and the information being used to associate the predetermined location displayed by the information medium as the location in the stockroom with the first product.

17. The system according to claim 1, wherein
the one or more processors are configured to add the first product to a list of products for which the stockroom is searched, receive from the terminal device a notification of taking out the first product from the storage unit located in the stockroom after notifying the location in the stockroom, and delete the first product from the list based on the receipt of the notification.

18. The system according to claim 1, wherein
the one or more processors are configured to receive from the terminal device a notification indicating that the first product is not found at the notified location in the stockroom, and eliminate the association of the first product and the location in the stockroom based on the receipt of the notification.

19. A terminal device comprising:
one or more memories; and
one or more processors configured to:
cause a first product to be loaded on a storage unit located in a stockroom in a retail store having a sales floor to be associated with a location in the stockroom by reading an information medium attached to the storage unit;
receive an operation of searching the stockroom for the first product, a plurality of storage units loaded with products being located in the stockroom; and
notify, in response to the operation, the location in the stockroom associated with the first product, the location in the stockroom being indicated by an identifier displayed on the information medium attached to the storage unit loaded with the first product.

20. A method for managing locations of products, comprising:
reading, by a terminal device, an information medium attached to a storage unit loaded with a first product in a stockroom in a retail store having a sales floor;
associating the first product with a location in the stockroom using information acquired from reading the information medium;
receiving an operation of searching the stockroom for the first product, a plurality of storage units loaded with products being located in the stockroom; and
notifying, in response to the operation, the location in the stockroom associated with the first product the first product, the location in the stockroom being indicated by an identifier displayed on the information medium attached to the storage unit loaded with the first product.
